(19) United States
(12) Patent Application Publication
(10) Pub. No.: US 2014/0114939 A1
(43) Pub. Date: Apr. 24, 2014

(54) SYSTEM, METHOD AND COMPUTER PROGRAM PRODUCT FOR DETERMINING ISSUES BETWEEN RULES

(71) Applicant: salesforce.com, inc., San Francisco, CA (US)

(72) Inventors: Peter Nicholas Miroslav Spacek, Fredericton (CA); Sean Greenlaw, Nasonworth (CA); Lance C. Clendenning, Fredericton (CA)

(73) Assignee: salesforce.com, inc., San Francisco, CA (US)

(21) Appl. No.: 14/047,979

(22) Filed: Oct. 7, 2013

Related U.S. Application Data
(60) Provisional application No. 61/716,010, filed on Oct. 19, 2012.

(51) Int. Cl. G06F 17/30

(52) U.S. Cl. CPC G06F 17/30289
USPC 707/694

(57) ABSTRACT

In accordance with embodiments, there are provided mechanisms and methods for determining issues between rules. These mechanisms and methods for determining issues between rules can enable improved system performance, increased system efficiency, enhanced user feedback, etc.

### CLAIM OF PRIORITY

This application claims the benefit of U.S. Provisional Patent Application No. 61/716,010, entitled “SYSTEM AND METHOD FOR LOOP AND PING-PONG DETECTION,” by Thompson et al., filed Oct. 19, 2012 (Attorney Docket No. 1074PROV), the entire contents of which are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

One or more implementations relate generally to rule evelopment, and more particularly to monitoring rule development within a system.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Many current systems utilize rules within the system to perform one or more actions in response to one or more conditions being met Unfortunately, techniques for monitoring the creation and alteration of such rules have been associated with various limitations. Just by way of example, current techniques have no means to identify and avoid a plurality of issues that may arise when an action is created or altered. Accordingly, it is desirable to provide techniques for determining issues between rules.

### BRIEF SUMMARY

In accordance with embodiments, there are provided mechanisms and methods for determining issues between rules. These mechanisms and methods for determining issues between rules can enable improved system performance, increased system efficiency, enhanced user feedback, etc.

In an embodiment and by way of example, a method for determining issues between rules is provided. In one embodiment, a change performed in association with a first rule is identified. Additionally, one or more additional rules that are associated with the first rule are detected. Further, it is determined whether one or more issues exist between the first rule and the one or more additional rules.

While one or more implementations and techniques are described with reference to an embodiment in which determining issues between rules is implemented in a system having an application server providing a front end for an on-demand database system capable of supporting multiple tenants, the one or more implementations and techniques are not limited to multi-tenant databases nor deployment on application servers. Embodiments may be practiced using other database architectures, i.e., ORACLE®, DB2® by IBM and the like without departing from the scope of the embodiments claimed.

Any of the above embodiments may be used alone or together with one another in any combination. The one or more implementations encompassed within this specification may also include embodiments that are only partially mentioned or alluded to or are not mentioned or alluded to at all in this brief summary or in the abstract. Although various embodiments may have been motivated by various deficiencies with the prior art, which may be discussed or alluded to in one or more places in the specification, the embodiments do not necessarily address any of these deficiencies. In other words, different embodiments may address different deficiencies that may be discussed in the specification. Some embodiments may only partially address some deficiencies or just one deficiency that may be discussed in the specification, and some embodiments may not address any of these deficiencies.

### BRIEF DESCRIPTION OF THE DRAWINGS

In the following drawings like reference numbers are used to refer to like elements. Although the following figures depict various examples, the one or more implementations are not limited to the examples depicted in the figures.

FIG. 1 illustrates a method for determining issues between rules, in accordance with one embodiment;

FIG. 2 illustrates a method for determining whether a ping pong event or loop event exist, in accordance with another embodiment;

FIG. 3 illustrates a block diagram of an example of an environment wherein an on-demand database system might be used; and

FIG. 4 illustrates a block diagram of an embodiment of elements of FIG. 5 and various possible interconnections between these elements.

### DETAILED DESCRIPTION

### General Overview

Systems and methods are provided for determining issues between rules,

As used herein, the term multi-tenant database system refers to those systems in which various elements of hardware and software of the database system may be shared by one or more customers. For example, a given application server may simultaneously process requests for a great number of customers, and a given database table may store rows for a potentially much greater number of customers.

Next, mechanisms and methods for determining issues between rules will be described with reference to example embodiments.

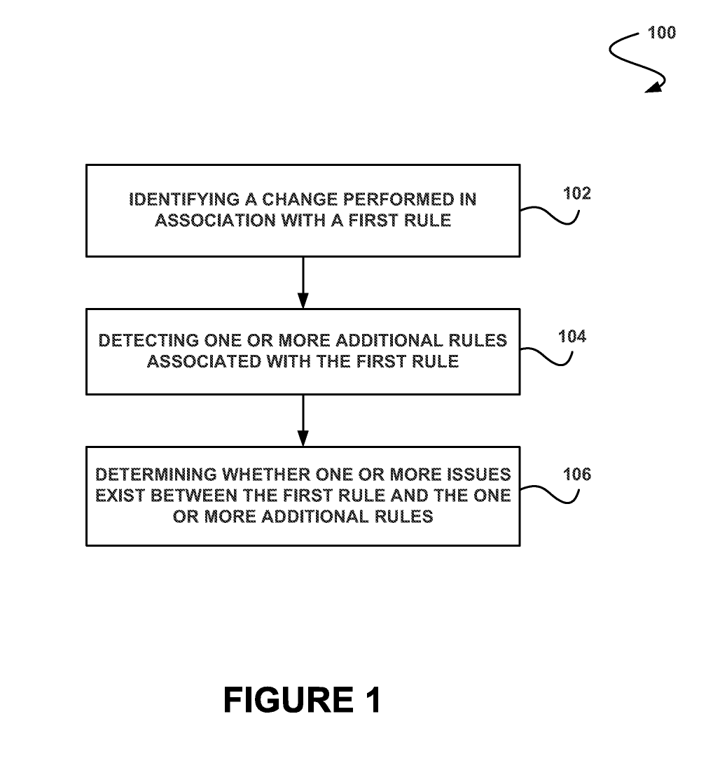

FIG. 1 illustrates a method 100 for determining issues between rules, in accordance with one embodiment. As shown in operation 102, a change performed in association with a first rule is identified. In one embodiment, a rule may include one or more conditions and one or more actions. For example, the first rule may include a single condition that triggers a single action. In another embodiment, the rule may include one or more input data elements. For example, the input data elements may include one or more objects such as an electronic mail message, a social network message, a blog or microblog message, an event indicator, a keyword, etc.

Additionally, in one embodiment, one or more input data elements may be input into the rule for processing by the rule. In another embodiment, the one or more input data elements may be compared to the one or more conditions of the rule. In yet another embodiment, one or more actions of the rule may be may be performed if the one or more data elements input into the rule meet the one or more conditions of the rule. For example, the one or more actions may include assigning data (e.g., the input data elements or other objects associated with the input data elements, etc.) to one or more entities, sending data to one or more entities, storing data, etc.

Further, in one embodiment, the rule may include an object within a system. For example, the object may be stored within a multi-tenant, on-demand database system. In another embodiment, the rule may be part of an application existing within the system. In yet another embodiment, the change that is performed may include the saving of the rule within a system (e.g., by a user, etc.). In still another embodiment, the change that is performed may include the creating of the rule (e.g., by a user, etc.). In another embodiment, the change that is performed may include the updating of the rule (e.g., by a user, etc.). In yet another embodiment, the performance of the change may be identified by monitoring one or more elements of the system (e.g., data creation within the system, data saving within the system, etc.).

Further still, it should be noted that, as described above, such multi-tenant on-demand database system may include any service that relies on a database system that is accessible over a network, in which various elements of hardware and software of the database system may be shared by one or more customers (e.g. tenants). For instance, a given application server may simultaneously process requests for a great number of customers, and a given database table may store rows for a potentially much greater number of customers. Various examples of such a multi-tenant on-demand database system will be set forth in the context of different embodiments that will be described during reference to subsequent figures.

Also, as shown in operation 104, one or more additional rules that are associated with the first rule are detected. In one embodiment, each of the one or more additional rules may include an object within the system. For example, each of the one or more additional rules may include objects that are stored in the system before the change is performed in association with the first rule.

In addition, in one embodiment, the one or more additional rules may be determined to be associated with the first rule if they share one or more characteristics with the first rule. For example, the one or more additional rules may be determined to be associated with the first rule if they share one or more input data elements with the first rule. In another example, the one or more additional rules may each have a single input data element that matches a single input data element of the first rule.

Furthermore, as shown in operation 106, it is determined whether one or more issues exist between the first rule and the one or more additional rules. In one embodiment, the one or more issues may include a ping pong event. For example, the ping pong event may include an event where the first rule and the one or more additional rules share an input data element and perform the same action in response to the input. In another embodiment, the ping pong event may continue until the input data element passes out of a predetermined search range within the system (e.g., there the input data element is no longer detected by the system, etc.).

Further still, in one embodiment, the one or more issues may include a loop event. For example, the loop event may include an event where the action performed by the first rule constitutes an input data element into one or more of the additional rules and satisfies a condition of the one or more rules (e.g., thereby triggering an action by the one or more rules), and where the action performed by the one or more additional rules constitutes an input data element into the first rule and satisfies a condition of the first rule (e.g., thereby triggering the action that had already been performed earlier by the first rule). In another embodiment, the loop event may continue until the input data element passes out of a predetermined search range within the system (e.g., there the input data element is no longer detected by the system, etc.).

Also, in one embodiment, determining whether one or more issues exist may include comparing the actions performed by the one or more additional rules to the action performed by the first rule. For example, when any of the actions performed by the one or more additional rules matches the action performed by the first rule, then aping pong event may be determined to exist.

Additionally, in one embodiment, determining whether one or more issues exist may include establishing a mapping between the one or more actions and one or more conditions of the first rule and the one or more actions and one or more conditions of each of the one or more additional rules. For example, the mapping may include a directed graph (e.g., a set of nodes connected by edges, etc.). In another embodiment, the action performed by the first rule may be used as the initial input of the mapping.

Further, in one embodiment, determining whether one or more issues exist may include determining whether a loop exists within the mapping, based on the initial input of the action performed by the first rule. For example, a first set of actions triggered by rules in the graph based on the initial input may be allowed to proceed within the mapping, and a second set of actions triggered by rules in the graph based on the first set of actions may also be allowed to proceed, and additional sets of actions may be allowed to proceed accordingly until it can be determined whether a loop exists within the mapping. In another example, if it is determined that a loop exists within the mapping, a loop event may be determined to exist.

Further still, in one embodiment, one or more actions may be performed, based on the determining. For example, if it is determined that one or more issues exist, one or more users of the system e.g., the user that performed the change in association with a first rule, etc.) may be notified. In another example, the one or more actions may be performed if it is determined that one or more issues exist. For instance, the actions may include refusing to save the first rule within the system, requesting a change to be made to the first rule or one or more of the additional rules associated with the first rule, etc. In this way, issues between the first rule and the one or more additional rules may be avoided.

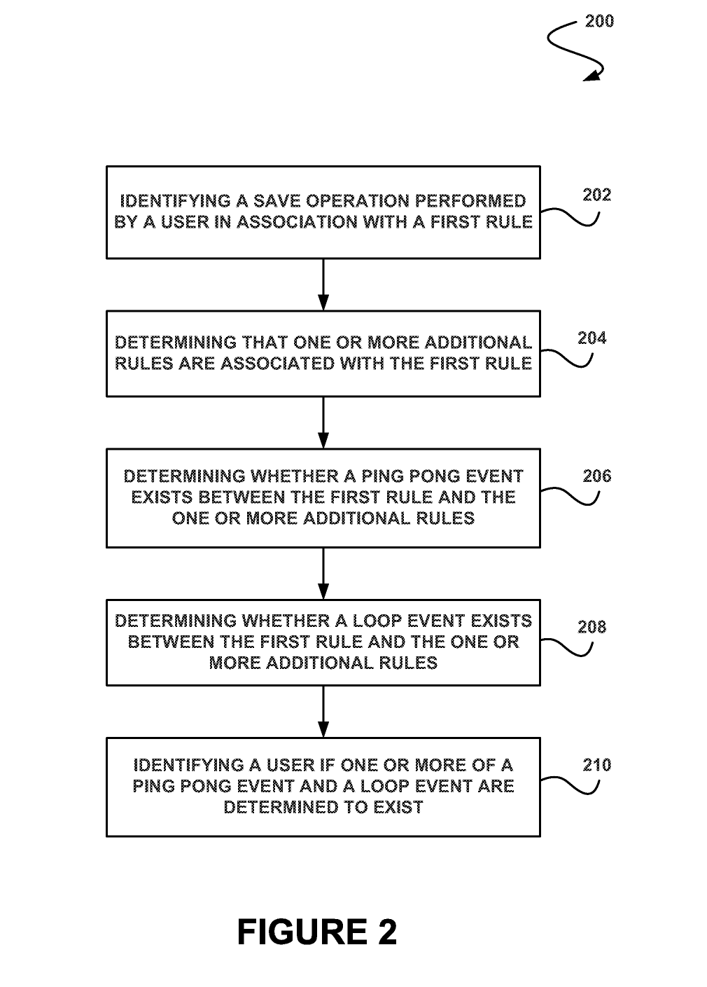

FIG. 2 illustrates a method 200 for determining whether a ping pong event or loop event exist, in accordance with another embodiment. As an option, the method 200 may be carried out in the context of the functionality of FIG. 1. Of course, however, the method 200 may be carried out in any desired environment. The aforementioned definitions may apply during the present description.

As shown in operation 202, a save operation performed by a user in association with a first rule is identified. In one embodiment, the save operation may include the saving of an updated rule by the user. In another embodiment, the save operation may include the saying of a newly created rule by the user. In yet another embodiment, the rule may include a rule stored within a system (e.g., as an object within the system, etc.). In still another embodiment, the rule may be associated with an organization registered with the system.

Additionally, in one embodiment, the user may perform the save operation utilizing an interface. For example, the user may perform the save operation after creating or modifying the first rule utilizing a graphical user interface (GUI) provided by the system. In another embodiment, the save operation may be identified by monitoring the system. For example, one or more applications within the system may monitor the system and may create an alert event when a save operation is performed in association with a rule.

Further, as shown in operation 204, it is determined that one or more additional rules are associated with the first rule. In one embodiment, determining that one or more additional rules are associated with the first rule may include comparing the first rule to the one or more additional rules. In another embodiment, the one or more additional rules that are associated with the first rule may include a subset of a larger set of rules that are compared to the first rule. In yet another embodiment, the one or more additional rules may each include an object stored within the system.

Further still, in one embodiment, comparing the first rule to the one or more additional rules may include comparing an input of the first rule to an input of the one or more additional rules. For example, a data element that is determined to be valid input into the first rule may be compared to data elements that are considered to be valid inputs into the one or more additional rules. In another embodiment, the input of the first rule may include data that is subsequently processed by the first rule. For example, the input of the first rule may be compared against a condition of the first rule, and an action may be conditionally performed by the first rule based on the comparison between the input and the condition of the first rule. For instance, the action may be performed by the rule if the input meets the condition of the first rule. Likewise, the input of each of the one or more additional rules may include data that is subsequently processed by the one or more additional rules.

Also, in one embodiment, it may be determined that the one or more additional rules are associated with the first rule if the one or more additional rules each have the same input as the input of the first rule. For example, a rule that processes data when a keyword within the data is “keywordA” will be determined to be associated with another rule that processes data when a keyword within the data is “keywordA.” However, a rule that processes data when a keyword within the data is “keywordA” will be determined to not be associated with another rule that processes data when a keyword within the data is “keywordB.” In this way, all rules within the system that share input with the first rule may be identified.

In addition, as shown in operation 206, it is determined whether a ping pong event exists between the first rule and the one or more additional rules. In one embodiment, determining whether the ping pong event exists may include comparing a condition of the first rule and an action performed by the first rule with a condition and an action of each of the one or more additional rules. For example, determining whether the ping pong event exists may include determining whether a condition of the first rule and an action performed by the first rule is the same as a condition and action of one or more of the one or more additional rules.

Further, in one embodiment, if it is determined that the condition and action of the first rule match the condition and action of one or more additional rules, then it may be determined that a ping pong event exists. In another embodiment, in response to the determination that a ping pong event exists, an identification of the one or more additional rules that have a condition and action matching the first rule may be stored.

Further still, as shown in operation 208, it is determined whether a loop event exists between the first rule and the one or more additional rules. In one embodiment, determining whether a loop event exists may include establishing a mapping between the first rule and the one or more additional rules. For example, a mapping may be established between the actions and conditions of the first rule and the actions and conditions of each of the one or more additional rules.

Also, in one embodiment, the mapping may include a directed graph. For example, each action and condition of each rule within the graph may constitute a node within the graph. In another embodiment, a directed edge may be created within the graph from a first node to a second node if the first node triggers the second node. For example, a directed edge may be created within the graph from an action node of one rule to a condition node of another rule if the action represented by the action node meets the condition represented by the condition node. In another example, no edge may be created within the graph from an action node of one rule to a condition node of another rule if the action represented by the action node does not meet the condition represented by the condition node.

Additionally, in one embodiment, the action perforated by the first rule may be set as the input to the mapping. For example, the action node associated with the first rule that is representative of the action performed by the rule may be set as the starting node of the directed graph. In another embodiment, it may be determined that a loop event exists between the first rule and the one or more additional rules if it is determined that a loop (e.g., an infinite loop, etc.) exists within the mapping. For example, it may be determined whether a directed edge exists between an action node associated with the first rule and a condition node associated with a second rule, and whether another directed edge exists between an action node associated with the second rule and a condition node associated with the first rule, such that a loop exists between the nodes associated with the first and second rule within the mapping.

Furthermore, in one embodiment, it may be determined that a loop event does not exist between the first rule and the one or more additional rules if it is determined that a loop (e.g., an infinite loop, etc.) does not exist within the mapping. In another embodiment, in response to the determination that a loop event exists, an identification of the one or more additional rules that are included in a loop within the mapping may be stored.

Further still, as shown in operation 210, the user is notified if one or more of a ping pong event and a loop event are determined to exist. In one embodiment, the user may include the user that performed the save operation. In another embodiment, notifying the user may include sending a text message to the user, sending an email to the user, presenting the user with a visual notification within a GUI (e.g., the GUI used to save the first rule, etc.), etc. In yet another embodiment, if it is determined that a ping pong event exists, an identification of the one or more additional rules that have a condition and action matching the first rule may presented to the user, still another embodiment, if it is determined that a loop event exists, an identification of the one or more additional rules that are included in a loop within the mapping may presented to the user. In another embodiment, the identification may include the listing of the condition and action within each rule.

In this way, ping pong and loop events may be identified and avoided during the creation and modification of rules within a system.

### System Overview

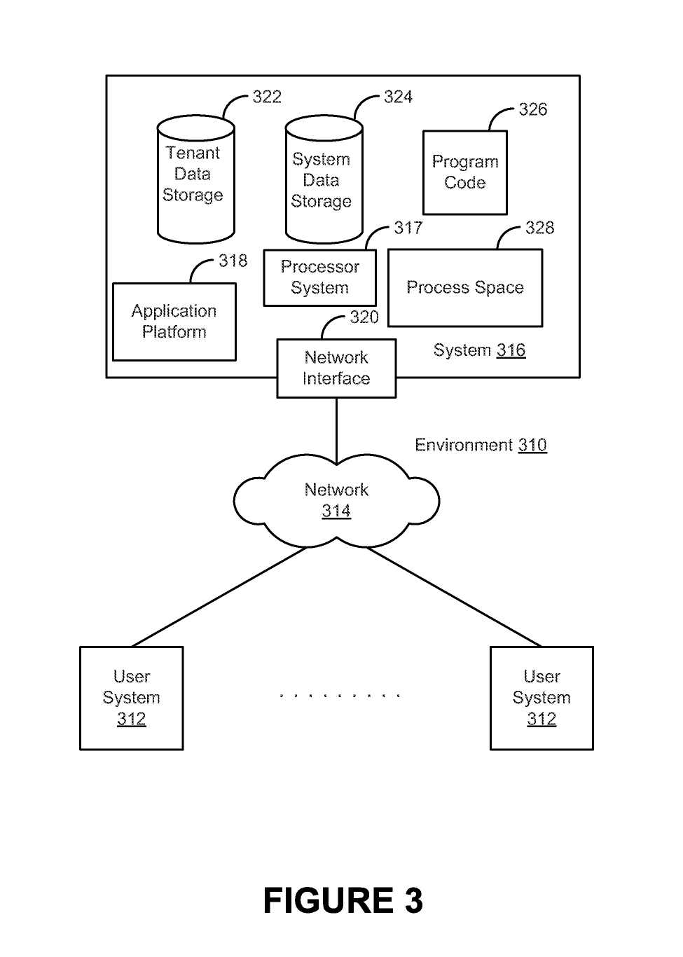

FIG. 3 illustrates a block diagram of an environment 310 wherein an on-demand database system might be used. Environment 310 may include user systems 312, network 314, system 316, processor system 317, application platform 318, network interface 320, tenant data storage 322, system data storage 324, program code 326, and process space 328. In other embodiments, environment 310 may not have all of the components listed and/or may have other elements instead of, or in addition to, those listed above.

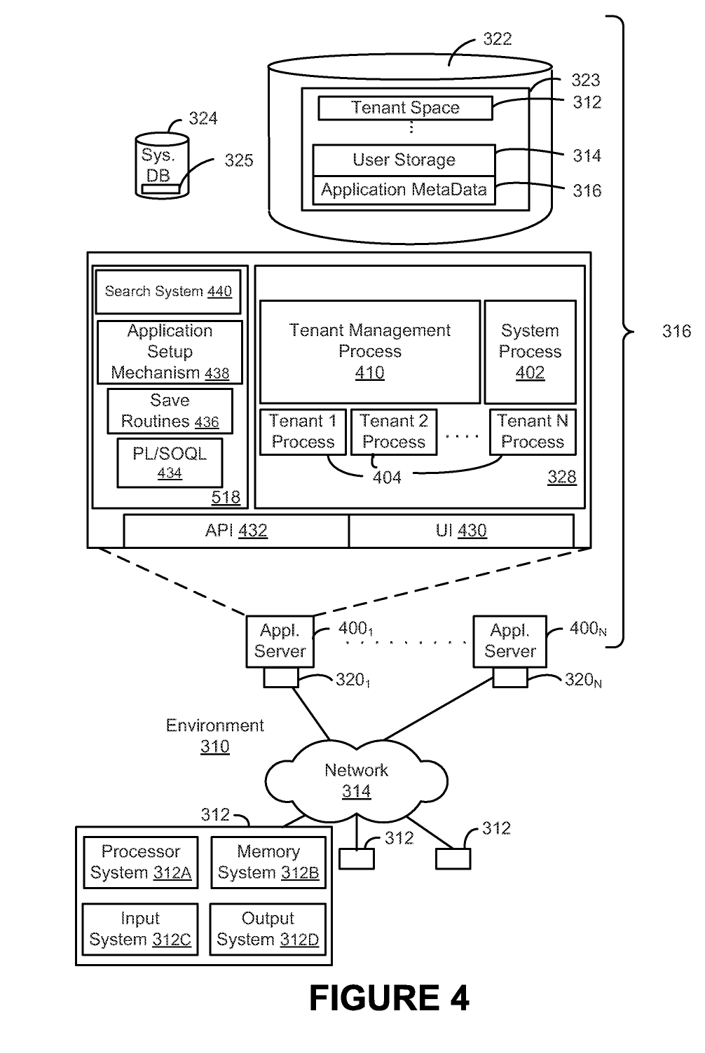

Environment 310 is an environment in which an on-demand database system exists. User system 312 may be any machine or system that is used by a user to access a database user system. For example, any of user systems 312 can be a handheld computing device, a mobile phone, a laptop computer, a work station, and/or a network of computing devices. As illustrated in FIG. 3 (and in more detail in FIG. 4) user systems 312 might interact via a network 314 with an on-demand database system, which is system 316.

An on-demand database system, such as system 316, is a database system that is made available to outside users that do not need to necessarily be concerned with building and/or maintaining the database system, but instead may be available for their use when the users need the database system (e.g., on the demand of the users). Some on-demand database systems may store information from one or more tenants stored into tables of a common database image to form a multi-tenant database system (MTS). Accordingly, “on-demand database system 316” and “system 316” will be used interchangeably herein. A database image may include one or more database objects. A relational database management system (RDMS) or the equivalent may execute storage and retrieval of information against the database object(s). Application platform 318 may be a framework that allows the applications of system 316 to run, such as the hardware and/or software, e.g., the operating system. In an embodiment, on-demand database system 316 may include an application platform 318 that enables creation, managing and executing one or more applications developed by the provider of the on-demand database system, users accessing the on-demand database system via user systems 312, or third party application developers accessing the on-demand database system via user systems 312.

The users of user systems 312 may differ in their respective capacities, and the capacity of a particular user system 312 might be entirely determined by permissions (permission levels) for the current user. For example, where a salesperson is using a particular user system 312 to interact with system 316, that user system has the capacities allotted to that salesperson. However, while an administrator is using that user system to interact with system 316, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 314 is any network or combination of networks of devices that communicate with one another. For example, network 314 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that the one or more implementations might use are not so limited, although TCP/IP is a frequently implemented protocol.

User systems 312 might communicate with system 316 using TCP/IP and, at a higher network level, use other common Internet protocols to communicate, such as HTTP, FTP, AFS, WAP, etc. In an example where HTTP is used, user system 312 might include an HTTP client commonly referred to as a “browser” for sending and receiving HTTP messages to and from an HTTP server at system 316. Such an HTTP server might be implemented as the sole network interface between system 316 and network 314, but other techniques might be used as well or instead. In some implementations, the interface between system 316 and network 314 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 316, shown in FIG. 3, implements a web-based customer relationship management (CRM) system. For example, in one embodiment, system 316 includes application servers configured to implement and execute CRM software applications as well as provide related data, code, forms, webpages and other information to and from user systems 312 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 316 implements applications other than, or in addition to, a CRM application. For example, system 316 may provide tenant access to multiple hosted (standard and custom) applications, including a CRM application. User (or third party developer) applications, which may or may not include CRM, may be supported by the application platform 318, which manages creation, storage of the applications into one or more database objects and executing of the applications in a virtual machine in the process space of the system 316.

One arrangement for elements of system 316 is shown in FIG. 3, including a network interface 320, application platform 318, tenant data storage 322 for tenant data 323, system data storage 324 for system data 325 accessible to system 316 and possibly multiple tenants, program code 326 for implementing various functions of system 316, and a process space 328 for executing MIS system processes and tenant-specific processes, such as running applications as part of an application hosting service. Additional processes that may execute on system 316 include database indexing processes.

Several elements in the system shown in FIG. 3 include conventional, well-known elements that are explained only briefly here. For example, each user system 312 could include a desktop personal computer, workstation, laptop, PDA, cell phone, or any wireless access protocol (WAP) enabled device or any other computing device capable of interfacing directly or indirectly to the Internet or other network connection. User system 312 typically runs an HTTP client, e.g., a browsing program, such as Microsoft's Internet Explorer browser, Netscape's Navigator browser, Opera's browser, or a WAR-enabled browser in the case of a cell phone, PDA or other wireless device, or the like, allowing a user (e.g., subscriber of the multi-tenant database system) of user system 312 to access, process and view information, pages and applications available to it from system 316 over network 314. Each user system 312 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 316 or other systems or servers. For example, the user interface device can be used to access data and applications hosted by system 316, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 312 and all of its components are operator configurable using applications, such as a browser, including computer code run using a central processing unit such as an Intel Pentium® processor or the like. Similarly, system 316 (and additional instances of an MTS, where more than one is present) and all of their components might be operator configurable using application(s) including computer code to run using a central processing unit such as processor system 317, which may include an Intel Pentium® processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 316 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, each system 316 is configured to provide webpages, forms, applications, data and media content to user (client) systems 312 to support the access by user systems 312 as tenants of system 316. As such, system 316 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 4 also illustrates environment 310. However, in FIG. 4 elements of system 316 and various interconnections in an embodiment are further illustrated. FIG. 4 shows that user system 312 may include processor system 312A, memory system 312B, input system 312C, and output system 312D. FIG. 4 shows network 314 and system 316. FIG. 4 also shows that system 316 may include tenant data storage 322, tenant data 323, system data storage 324, system data 325, User Interface (UI) 430, Application Program Interface (API) 432, PL/SOQL 434, save routines 436, application setup mechanism 438, applications servers 400₁-400_{N}, system process space 402, tenant process spaces 404, tenant management process space 410, tenant storage area 412, user storage 414, and application metadata 416. In other embodiments, environment 310 may not have the same elements as those listed above and/or may have other elements instead of, or in addition to, those listed above.

User system 312, network 314, system 316, tenant data storage 322, and system data storage 324 were discussed above in FIG. 3. Regarding user system 312, processor system 312A may be any combination of one or more processors. Memory system 312B may be any combination of one or more memory devices, short term, and/or long term memory. Input system 312C may be any combination of input devices, such as one or more keyboards, mice, trackballs, scanners, cameras, and/or interfaces to networks. Output system 312D may be any combination of output devices, such as one or more monitors, printers, and/or interfaces to networks. As shown by FIG. 4, system 316 may include a network interface 320 (of FIG. 3) implemented as a set of HTTP application servers 400, an application platform 318, tenant data storage 322, and system data storage 324. Also shown is system process space 402, including individual tenant process spaces 404 and a tenant management process space 410. Each application server 400 may be configured to tenant data storage 322 and the tenant data 323 therein, and system data storage 324 and the system data 325 therein to serve requests of user systems 312. The tenant data 323 might be divided into individual tenant storage areas 412, which can be either a physical arrangement and/or a logical arrangement of data. Within each tenant storage area 412, user storage 414 and application metadata 416 might be similarly allocated for each user. For example, a copy of a user's most recently used (MRU) items might be stored to user storage 414, Similarly, a copy of MRU items for an entire organization that is a tenant might be stored to tenant storage area 412, A UI 430 provides a user interface and an API 432 provides an application programmer interface to system 316 resident processes to users and/or developers at user systems 312. The tenant data and the system data may be stored in various databases, such as one or more Oracle™ databases.

Application platform 318 includes an application setup mechanism 438 that supports application developers' creation and management of applications, which may be saved as metadata into tenant data storage 322 by save routines 436 for execution by subscribers as one or more tenant process spaces 404 managed by tenant management process 410 for example. Invocations to such applications may be coded using PL/SOQL 434 that provides a programming language style interface extension to API 432. A detailed description of some PL/SOQL language embodiments is discussed in commonly owned co-pending U.S. Provisional Patent Application 60/828,192 entitled, PROGRAMMING LANGUAGE METHOD AND SYSTEM FOR EXTENDING APIS TO EXECUTE IN CONJUNCTION WITH DATABASE APIS, by Craig Weissman, filed Oct. 4, 2006, which is incorporated in its entirety herein for all purposes. Invocations to applications may be detected by one or more system processes, which manages retrieving application metadata 416 for the subscriber making the invocation and executing the metadata as an application in a virtual machine.

Each application server 400 may be communicably coupled to database systems, e.g., having access to system data 325 and tenant data 323, via a different network connection. For example, one application server 400₁ might be coupled via the network 314 (e.g., the Internet), another application server 400_{N-1} might be coupled via a direct network link, and another application server 400_{N} might be coupled by yet a different network connection. Transfer Control Protocol and Internet Protocol (TCP/IP) are typical protocols for communicating between application servers 400 and the database system. However, it will be apparent to one skilled in the art that other transport protocols may be used to optimize the system depending on the network interconnect used.

In certain embodiments, each application server 400 is configured to handle requests for any user associated with any organization that is a tenant. Because it is desirable to be able to add and remove application servers from the server pool at any time for any reason, there is preferably no server affinity for a user and/or organization to a specific application server 400. In one embodiment, therefore, an interface system implementing a load balancing function (e.g., an F5 Big-IP load balancer) is communicably coupled between the application servers 400 and the user systems 312 to distribute requests to the application servers 400. In one embodiment, the load balancer uses a least connections algorithm to route user requests to the application servers 400. Other examples of load balancing algorithms, such as round robin and observed response time, also can be used. For example, in certain embodiments, three consecutive requests from the same user could hit three different application servers 400, and three requests from different users could hit the same application server 400. In this manner, system 316 is multi-tenant, wherein system 316 handles storage of, and access to, different objects, data and applications across disparate users and organizations.

As an example of storage, one tenant might be a company that employs a sales force where each salesperson uses system 316 to manage their sales process. Thus, a user might maintain contact data, leads data, customer follow-up data, performance data, goals and progress data, etc., all applicable to that user's personal sales process (e.g., in tenant data storage 322). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 316 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 316 might also maintain system level data usable by multiple tenants or other data. Such system level data might include industry reports, news, postings, and the like that are sharable among tenants.

In certain embodiments, user systems 312 (which may be client systems) communicate with application servers 400 to request and update system-level and tenant-level data from system 316 that may require sending one or more queries to tenant data storage 322 and/or system data storage 324. System 316 (e.g., an application server 400 in system 316) automatically generates one or more SQL statements (e.g., one or more SQL queries) that are designed to access the desired information. System data storage 324 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. patent application Ser. No. 10/817,161, filed Apr. 2, 2004, entitled “Custom Entities and Fields in a Multi-Tenant Database System”, and which is hereby incorporated herein by reference, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

1. A computer program product embodied on a tangible computer readable medium, comprising:
computer code for identifying a change performed in association with a first rule;
computer code for detecting one or more additional rules that are associated with the first rule; and
computer code for determining whether one or more issues exist between the first rule and the one or more additional rules.

2. The computer program product of claim 1, wherein the rule includes a condition that triggers an action.

3. The computer program product of claim 1, therein the rule includes an object within system.

4. The computer program product of claim 3, wherein e change that is performed includes a saving of the rule within the system.

5. The computer program product of claim 3, wherein each of the one or more additional rules include objects that are stored in the system before the change is performed in association with the first rule.

6. The computer program product of claim I, wherein the one or more additional rules are determined to be associated with the first rule if they share one or more characteristics with the first rule.

7. The computer program product of claim I, wherein the one or more additional rules are determined to be associated with the first rule if they share one or more input data elements with the first rule.

8. The computer program product of claim 1, wherein the one or more issues include a ping pong event.

9. The computer program product of claim 8, wherein the ping pong event includes an event where the first rule and the one or more additional rules share an input data element and perform the same action in response to the input data element.

10. The computer program product of claim 1, wherein the one or more issues include a loop event.

11. The computer program product of claim 10, wherein the loop event includes an event where an action performed by the first rule constitutes an input data element into one or more of the additional rules and satisfies a condition of the one or more additional rules, and where the action performed by the one or more additional rules constitutes an input data element into the first rule and satisfies a condition of the first rule.

12. The computer program product of claim 1, wherein determining whether one or more issues exist includes comparing the actions performed by the one or more additional rules to the action performed by the first rule.

13. The computer program product of claim 12, wherein when any of the actions performed by the one or more additional rules matches the action performed by the first rule, then aping pong event is determined to exist.

14. The computer program product of claim 1, wherein determining whether one or more issues exist includes establishing a mapping between one or more actions and one or more conditions of the first rule and one or more actions and one or more conditions of each of the one or more additional rules.

15. The computer program product of claim 14, wherein the mapping includes a directed graph.

16. The computer program product of claim 15, wherein the action performed by the first rule is used as an initial input of the mapping.

17. The computer program product of claim 15, wherein determining whether one or more issues exist includes determining whether a loop exists within the mapping.

18. The computer program product of claim 1, further comprising notifying one or more users of a system when it is determined that one or more issues exist between the first rule and the one or more additional rules.

19. A method, comprising:
identifying a change performed in association with a first rule;
detecting one or more additional rules that are associated with the first rule; and
determining whether one or more issues exist between the first rule and the one or more additional rules.

20. An apparatus, comprising:
a processor for:
identifying a change performed in association with a first rule;
detecting one or more additional rules that are associated with the first rule; and
determining whether one or more issues exist between the first rule and the one or more additional rules.

21. A method for transmitting code for use in a multi-tenant database system on a transmission medium, the method comprising:
transmitting code for identifying a change performed in association with a first rule;
transmitting code for detecting one or more additional rules that are associated with the first rule; and
transmitting code for determining whether one or more issues exist between the first rule and the one or more additional rules.
